(19) United States
(12) Patent Application Publication
(10) Pub. No.: US 2022/0278342 A1
(43) Pub. Date: Sep. 1, 2022

(54) HUMIDIFIER, FUEL CELL DEVICE WITH HUMIDIFIER AND MOTOR VEHICLE

(71) Applicants: AUDI AG, Ingolstadt (DE); Volkswagen AG, Wolfsburg (DE)

(72) Inventors: Rune STAECK, Gifhorn (DE); Tore WESTPHAL, Meine (DE)

(21) Appl. No.: 17/631,681

(22) PCT Filed: Apr. 28, 2020
(86) PCT No.: PCT/EP2020/061805

§ 371 Date: Jan. 31, 2022

(30) Foreign Application Priority Data
Aug. 1, 2019 (DE) 10 2019 211 589.6

(51) Int. Cl. H01M 8/04119; H01M 8/04029; H01M 8/0258; H01M 8/0267; H01M 8/04701; H01M 8/04828; H01M 8/1007

(52) U.S. Cl. CPC H01M 8/04149; H01M 8/04029; H01M 8/0258; H01M 8/0267; H01M 8/04701; H01M 8/04835; H01M 8/1007; H01M 2250/20; H01M 2008/1095

(57) ABSTRACT

A humidifier for a fuel cell device is provided which includes a water vapor permeable membrane and at least one flow field arranged on one side of the membrane, in which flow channels are separated by flow field webs. The flow field webs are designed as hollow webs for integration into a coolant circuit. A fuel cell device with a humidifier as well as to a motor vehicle with such a fuel cell device are also provided.

### BACKGROUND

### Technical Field

Embodiments of the invention relate to a humidifier for a fuel cell device with a water vapor permeable membrane and at least one flow field arranged on one side of the membrane, in which flow channels are separated by flow field webs which are designed as hollow webs for integration into a coolant circuit. Embodiments of the invention further relate to a fuel cell device and to a motor vehicle.

### Description of the Related Art

Generally, humidifiers are used to be able to carry out a transfer of moisture from one medium to another drier medium in the case of two gaseous media with different moisture content. Gas/gas humidifiers of this type are in particular used in fuel cell devices in which air containing oxygen is compressed in the cathode circuit to feed the cathode chambers of the fuel cell stack, such that relatively warm and dry compressed air is present, the humidity of which is not sufficient for use in the fuel cell stacks for the membrane electrode unit. The dry air provided by the compressor for the fuel cell stack is humidified by having it flow by a water vapor permeable membrane, the other side of which membrane is swept with the moist exhaust air from the fuel cell stack. To condition the air to be fed to the cathode chambers of the fuel cell stack, it must also be tempered, for which purpose intercoolers are usually positioned downstream of the compressor. The humidifier and the intercooler are large components which contribute to an important increase in the installation space required for a fuel cell device and limit the efficiency of the fuel cell device because of the existence of high thermal losses.

DE 10 2013 004 799 A1 describes a humidifier in which a water vapor permeable membrane has a first layer arrangement on a first side, which comprises a plurality of flow webs running parallel to the membrane, and in which a second layer arrangement is present on a second side of the membrane, which also comprises a plurality of flow webs running parallel to the membrane and delimiting flow channels. At least a portion of the flow webs of the second flow layer are formed with a plurality of stabilization points in the form of local increases in web width.

US 2008/0075993 A1 describes a bipolar plate with pores, which are covered by membranes and which selectively allow to pass through the membrane and to moisten a reaction gas.

DE 10 2015 122 144 A1 provides a humidifier with integrated water separator, wherein a plurality of separate separator elements are arranged on the first side of the membrane.

### BRIEF SUMMARY

Some embodiments provide a humidifier with improved efficiency as well as an improved fuel cell device and an improved motor vehicle.

In some embodiments, flow field webs of a humidifier are designed as hollow webs for integration into a coolant circuit, which is to say that the possibility is opened up of being able to supply heat to the flow field or to the medium flowing in the flow channels in order, on the one hand, to promote the evaporation of liquid water and, on the other hand, to counteract the drop in temperature during the evaporation of the liquid water.

In order to provide a large surface area for heat transfer, it is envisaged that the hollow webs are designed as a polygon in cross-section. The flow field webs are also made of a thermally conductive material to promote heat transfer.

The flow field web may have a water reservoir on its outer side, as this allows discontinuously occurring liquid water to be stored for release when operating conditions exist without the introduction of liquid water.

It has proven to be useful if the water reservoir is formed by a hygroscopic material. In addition or alternatively, it is also possible for the flow field webs to have a porous structure. Water can also be stored in the pores.

The fact that the flow field is arranged in a heat-insulating frame also serves to improve the tempering of the medium passing through the flow channels.

As regards the use of common parts for a cost-effective manufacturing and for simplicity of construction as well as for the efficiency of humidification, a second, similarly formed flow field may be arranged on the side of the membrane opposite the flow field for the passage of the gas to be humidified.

If the humidifier is assigned to a fuel cell device, a cooling circuit is already available, such that a cooling circuit of a fuel cell stack may be routed through the flow field webs of the humidifier formed as hollow webs. Furthermore, it is also possible that the flow channels are flow-connected to a water separator of the fuel cell stack in order to thereby have a source of liquid water.

A motor vehicle with such a fuel cell device requires less installation space and can be operated more efficiently.

The features and combinations of features mentioned above in the description as well as the features and combinations of features mentioned below in the description of the figures and/or shown alone in the figures can be used not only in the combination indicated in each case, but also in other combinations or on their own, without departing from the scope of the invention. In this manner, embodiments are also to be regarded as encompassed and disclosed by the invention which are not explicitly shown or explained in the figures, but which arise from and can be generated from separate combinations of features of the embodiments which are elucidated.

### BRIEF DESCRIPTION OF THE SEVERAL VIEWS OF THE DRAWINGS

Further advantages, features and details are apparent from the claims, the following description, and the drawings.

FIG. 1 shows a schematic representation of a fuel cell device comprising a humidifier.

FIG. 2 shows a schematic representation of a flow field of a humidifier with coolant channels separated by webs, with water reservoirs associated with the webs and depicted while empty.

FIG. 3 shows a cross-section through the flow field from FIG. 2.

FIG. 4 shows a representation corresponding to FIG. 2 with the water reservoir when full.

FIG. 5 shows a representation corresponding to FIG. 3 for the flow field from FIG. 4.

FIG. 6 shows a representation corresponding to FIG. 3 of an alternative embodiment with modified webs.

FIG. 7 shows a representation corresponding to FIG. 5 of the alternative embodiment from FIG. 6.

### DETAILED DESCRIPTION

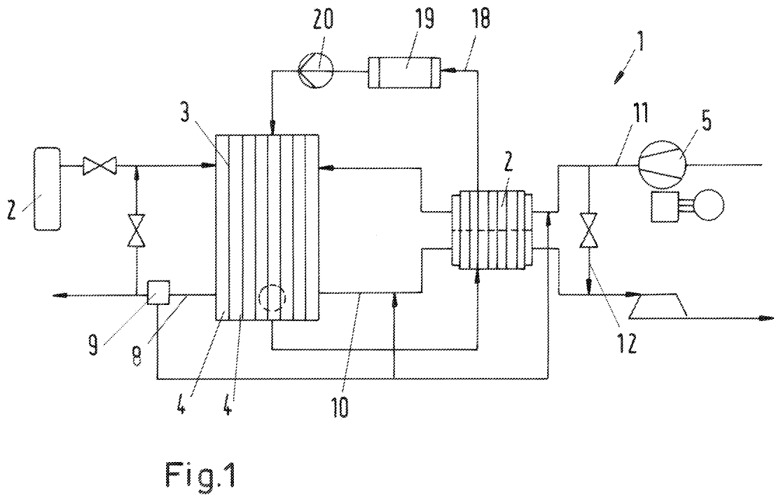

FIG. 1 schematically shows a fuel cell device 1 comprising a humidifier 2 for regulating the humidity of a plurality of fuel cells 4 combined in a fuel cell stack 3.

Each of the fuel cells 4 comprises an anode, a cathode, as well as a proton-conductive membrane separating the anode from the cathode. The membrane is formed from an ionomer, such as a sulfonated polytetrafluoroethylene (PTFE) polymer or a perfluorinated sulfonic acid (PFSA) polymer. Alternatively, the membrane may be formed as a sulfonated hydrocarbon membrane.

The anodes and/or the cathodes may additionally be admixed to a catalyst, wherein the membranes may be coated on their first side and/or on their second side with a catalyst layer of a noble metal or a mixture comprising noble metals such as platinum, palladium, ruthenium or the like, which serve as reaction accelerators in the reaction of the respective fuel cell.

The anode fuel (for example, hydrogen) can be supplied to the anode via an anode compartment. In a polymer electrolyte membrane fuel cell (PEM fuel cell), fuel or fuel molecules are split into protons and electrons at the anode. The PEM allows the protons to pass through, but is impermeable to the electrons. At the anode, for example, the following reaction takes place: 2H₂→4H⁺+4e⁻ (oxidation/electron release). Whereas the protons pass through the PEM to the cathode, the electrons are directed to the cathode or to an energy storage device via an external power circuit.

The cathode gas (for example, oxygen or oxygen-containing air) can be supplied to the cathode via a cathode chamber, such that the following reaction takes place on the cathode side: O₂+4H⁺+4e⁻→2H₂O (reduction/electron capture).

Since several fuel cells 4 are combined in the fuel cell stack 3, a sufficiently large amount of cathode gas must be provided, so that a large cathode gas mass flow or fresh gas flow is provided by a compressor 5, wherein as a result of the compression of the cathode gas, its temperature increases greatly. The conditioning of the cathode gas or of the fresh air gas stream, which is to say its adjustment with regard to the temperature and humidity desired in the fuel cell stack 3, takes place in an intercooler, not shown in more detail, downstream of the compressor 5, as well as in the humidifier 2, which causes moisture saturation of the membranes of the fuel cells 4 to increase their efficiency, since this promotes proton transport.

On the anode side, the fuel cell stack 3 is fluid-mechanically connected to an anode supply line 6, such that fuel contained in the schematically shown fuel storage 7 can be supplied to the fuel cell stack 3. A valve or even a suction jet pump can be suitable to realize the desired partial pressure of fresh fuel within the anode circuit, which is created by the anode recirculation line 8. With such an anode recirculation line 8, the fuel not consumed in the fuel cell stack 3 can be supplied once again to the anode chambers upstream of the fuel cell stack 3, such that the anode recirculation line 8 once again opens out into the anode supply line 6. To remove the liquid from the anode circuit, a separator 9 is integrated in the anode recirculation line 8. This is fluid-mechanically connected to the cathode side of the fuel cell device 1, such that the liquid accumulating on the anode side is introduced, for example, into the cathode exhaust line 10 provided downstream of the fuel cell stack 3, in order to convey the liquid, for example, out from the fuel cell device 1. Alternatively or additionally, the liquid accumulating on the anode side can also discharge from the separator 9 into a cathode supply line 11 upstream of the humidifier 2, such that the liquid is introduced there into the fresh cathode gas before it enters the humidifier 2. This has the advantage that the humidifier 2 can be designed to be smaller overall, since the fresh gas, which has been dried by compression using the compressor 5, no longer needs to be humidified to such an extent in order to ensure the required humidity of the membranes in the fuel cell stack 3.

In order to be able to regulate the mass flow of the cathode gas through the fuel cell stack 3, a bypass 12 is provided which has an actuating element, in particular a pressure regulating valve. This bypass 12 connects the cathode supply line 11 with the cathode exhaust line 10.

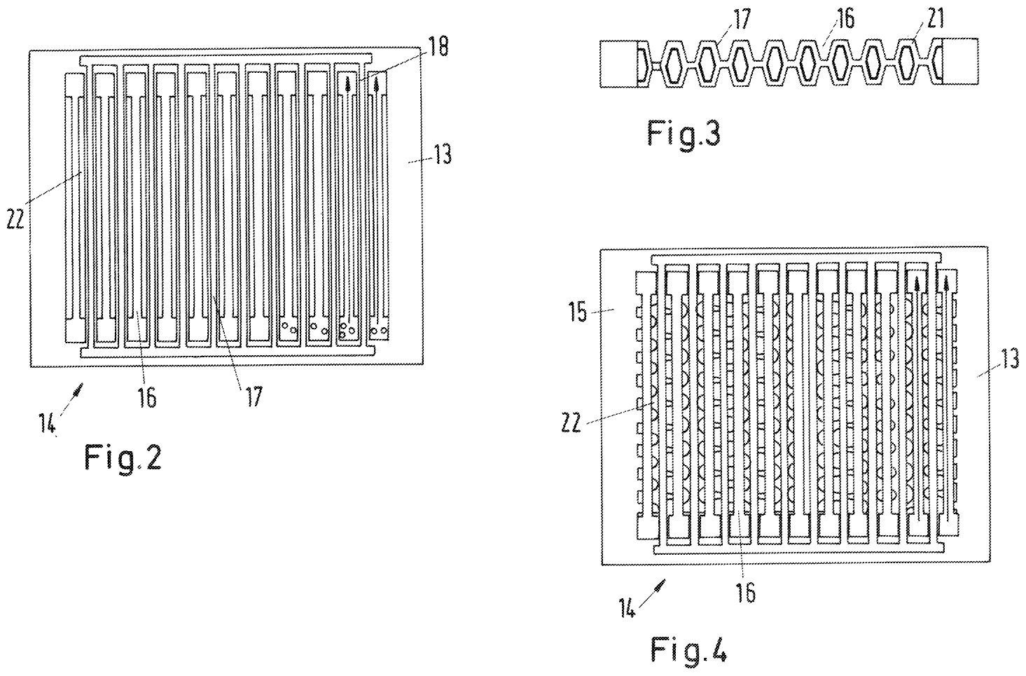

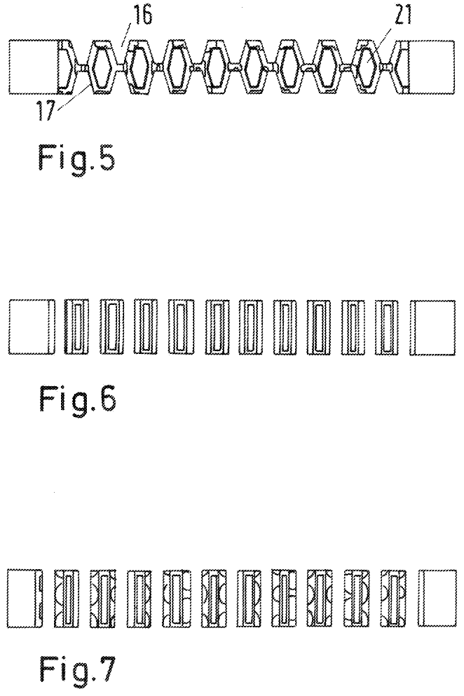

In the embodiment shown in FIG. 1, the humidifier 2 is constructed as a planar humidifier with several humidifier modules 13 (FIG. 2), each of which is formed with a water vapor permeable membrane and a flow field 14 arranged on one side of the membrane and a second flow field 14 arranged on the opposite side of the membrane, which are arranged in a heat-insulating frame 15, which is to say, that poorly conducts heat. Flow channels 16 are separated by flow field webs 17 in the flow fields 14, wherein the flow field webs 17 are designed as hollow webs (FIG. 3) for integration into a coolant circuit 18, namely into the coolant circuit 18 of the fuel cell stack 3 of the fuel cell device 1, which has a cooler 19 and a coolant pump 20, which in the embodiment example shown in FIG. 1 are arranged downstream of the humidifier 2 in the coolant circuit 18. The heat dissipated with the coolant from the fuel cell stack 3 is thus used to heat the gas flowing in the flow channels 16 and to counteract the cooling that occurs due to the evaporation of the liquid water. This heat supply is also associated with a higher liquid water conversion. This is achieved by designing the hollow webs as a cross-sectional polygon 21 to increase the surface area and by forming them from a heat-conducting material.

This heat utilization upstream of the cooler 19 also means that the cooler is required to extract less heat from the coolant and can therefore optionally be made smaller.

Furthermore, the liquid water accumulated in the fuel cell stack 3 and collected in the separator 9 is utilized in that the flow channels 16 are flow-connected to the separator 9 of the fuel cell stack 9. On the fresh gas side, this leads to humidification, such that less water transfer through the membrane is required and therefore the membrane area and consequently the size of the humidifier 2 can be reduced. On the cathode exhaust side, this leads to the humidification of the cathode exhaust.

Since the flow field web 17 has a water reservoir 22 on its outside, it is possible to fill this water reservoir 22 when liquid water is available and to release the stored water when less liquid water is available from the separator 9. The water reservoir 22 is formed by a hygroscopic material which is placed, glued or pressed onto the flow field webs 17. It is also possible for the flow field webs 17 to have a porous structure.

In a motor vehicle with a fuel cell device 1 and a humidifier 2 of this type, less installation space is required for the humidifier 2, which can be manufactured more compactly and accordingly with less material.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A humidifier for a fuel cell device, the humidifier comprising:
a water vapor permeable membrane; and
at least one flow field arranged on one side of the membrane;
wherein the flow field includes flow channels separated by flow field webs;
wherein the flow field webs are hollow and configured for integration into a coolant circuit;
wherein the flow field webs have respective cross-sectional shapes comprising polygons;
wherein the flow field webs have respective water reservoirs on respective external sides of the flow field webs; and
wherein the water reservoirs are formed of a hydroscopic material.

2. (canceled)

3. The humidifier according to claim 1, wherein the flow field webs are formed of a heat-conducting material.

4-5. (canceled)

6. The humidifier according to claim 1, wherein the flow field webs have respective porous structures.

7. The humidifier according to claim 1, wherein the flow field is arranged in a heat insulating frame.

8. The humidifier according to claim 1, wherein on the side of the membrane opposite the flow field, there is a second, similarly formed flow field for the passage of a gas to be humidified.

9. A fuel cell device, comprising:
a fuel cell stack including a cooling circuit; and
a humidifier including:
a water vapor permeable membrane; and
at least one flow field arranged on one side of the membrane;
wherein the flow field includes flow channels separated by flow field webs;
wherein the flow field webs are hollow;
wherein the flow field webs have respective cross-sectional shapes comprising polygons;
wherein the flow field webs have respective water reservoirs on respective external sides of the flow field webs; and
wherein the water reservoirs are formed of a hydroscopic material;
wherein the cooling circuit is routed through the flow field webs of the humidifier; and
wherein the flow channels are flow-connected with a separator of the fuel cell stack.

10. A motor vehicle, comprising:
a fuel cell device including:
a fuel cell stack including a cooling circuit; and
a humidifier including:
a water vapor permeable membrane; and
at least one flow field arranged on one side of the membrane;
wherein the flow field includes flow channels separated by flow field webs;
wherein the flow field webs are hollow;
wherein the flow field webs have respective cross-sectional shapes comprising polygons;
wherein the flow field webs have respective water reservoirs on respective external sides of the flow field webs; and
wherein the water reservoirs are formed of a hydroscopic material;
wherein the cooling circuit is routed through the flow field webs of the humidifier; and
wherein the flow channels are flow-connected with a separator of the fuel cell stack.
